(19) United States
(12) Patent Application Publication
(10) Pub. No.: US 2013/0126569 A1
(43) Pub. Date: May 23, 2013

(54) ADJUSTABLE SUPPORT DEVICE FOR BIKE AUXILIARY HANDLES

(71) Applicant: YAO-CHING HUANG, Taichung City (TW)

(72) Inventor: YAO-CHING HUANG, Taichung City (TW)

(21) Appl. No.: 13/302,024

(22) Filed: Nov. 22, 2011

(51) Int. Cl. B62J 11/00

(52) U.S. Cl. 224/414; 224/420

(57) ABSTRACT

An adjustable support device for bike auxiliary handles includes a support member, a clamping unit and an adjustment unit. The support member is used to support an article. The clamping unit is perpendicularly coupled to the support member. The clamping unit is adjustable between a tightened position and a loosened position. The adjustment unit is used for adjustment in a horizontal direction for the clamping unit to be coupled to two parallel auxiliary handles. The distance between the two auxiliary handles and the support device can be adjusted as desired.

### BACKGROUND OF THE INVENTION

1. Field of the Invention

The present invention relates to an adjustable support device which is coupled to two parallel bike auxiliary handles. The distance between the two auxiliary handles and the support device can be adjusted as desired.

2. Description of the Prior Art

As shown in FIG. 10, conventional bike auxiliary handles 70 are disposed in parallel. The rear ends 71 of the auxiliary handles 70 are coupled to a main handle 80. The two auxiliary handles 70 are disposed in the front direction. A pair of arm rests 90 is provided at outer sides of the two auxiliary handles 70. The rider can grasp the two sides of the main handle 80 with his/her hands or the auxiliary handles 70 as desired. When grasping the auxiliary handles 70, the rider can put his/her elbows on the arm rests 90 for his/her hands to have a rest.

The aforesaid auxiliary handles 70 only have a function to provide the rider another grasping way during riding. Recently, bike riding becomes a popular sport all over the world, which is environment-friendly and healthy. Some riders take a trip by riding a bike for a long journey. Besides, there are various bike contests in the world. For a long journey or a bike contest, the bike rider may carry a water bottle, a GPS, a stopwatch, or other article. It will become a burden to the rider if the aforesaid articles are taken along. Some devices are developed to connect the aforesaid articles to a bike. For example, a water bottle support is coupled to an upper pipe of the bike frame or a seat pipe of the bike frame. The stopwatch or GPS can be mounted on the bike handle. They are mounted at different positions to cause complication of assembly. Accordingly, the inventor of the present invention has devoted himself based on his many years of practical experiences to solve these problems and to develop a support device for a water bottle, a GPS, a stopwatch, or other article.

### SUMMARY OF THE INVENTION

The primary object of the present invention is to provide an adjustable support device which is coupled to two parallel bike auxiliary handles. The distance between the two auxiliary handles and the support device can be adjusted as desired.

In order to achieve the aforesaid object, the adjustable support device of the present invention comprises a support member, a clamping unit and an adjustment unit. The support member is adapted to support an article. The clamping unit is perpendicularly coupled to the support member. The clamping unit is adjustable between a tightened position and a loosened position. The adjustment unit is used for adjustment in a horizontal direction for the clamping unit to be coupled to two parallel auxiliary handles. When the clamping unit is at the loosened position, the adjustment unit is adjustable between a minimum distance and a maximum distance. When the clamping unit is at the tightened position, the adjustment unit is positioned in place.

### BRIEF DESCRIPTION OF THE DRAWINGS

FIG. 1 is an exploded view according to a preferred embodiment of the present invention;

FIG. 2 is another exploded view showing the first and second adjustment members according to the preferred embodiment of the present invention;

FIG. 3 is a schematic view according to the preferred embodiment of the present invention coupled to the auxiliary handles;

FIG. 4 is a side sectional view according to the preferred embodiment of the present invention;

FIG. 5 is a side sectional view showing the auxiliary handles adjusted to the minimum distance according to the preferred embodiment of the present invention;

FIG. 6 is a side sectional view showing the adjustment of the preferred embodiment of the present invention;

FIG. 7 is a side sectional view showing the auxiliary handles adjusted to the maximum distance according to the preferred embodiment of the present invention;

FIG. 8 is a schematic view showing the support member in a use state according to the preferred embodiment of the present invention;

FIG. 9 is a schematic view showing the support member in another use state according to the preferred embodiment of the present invention; and

FIG. 10 is a schematic view showing conventional bike auxiliary handles.

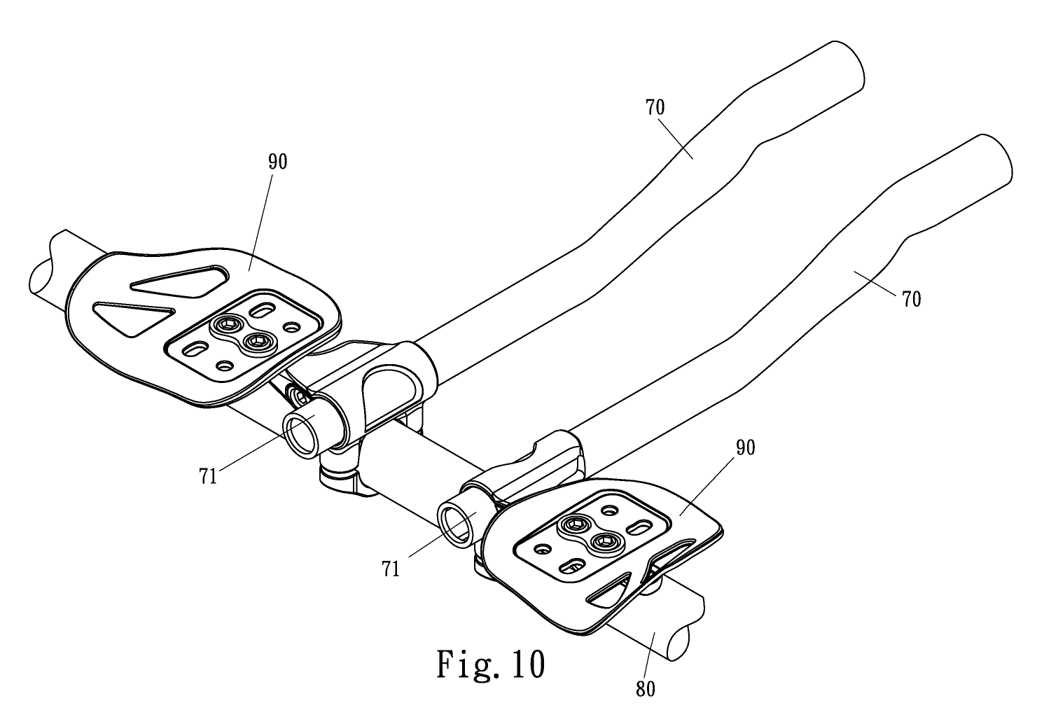

### DETAILED DESCRIPTION OF THE PREFERRED EMBODIMENTS

Embodiments of the present invention will now be described, by way of example only, with reference to the accompanying drawings.

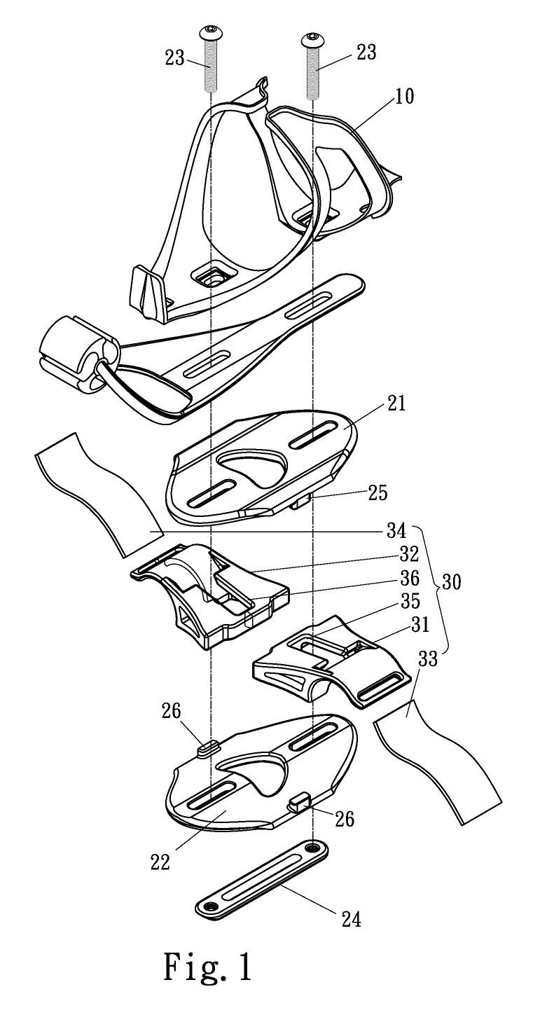

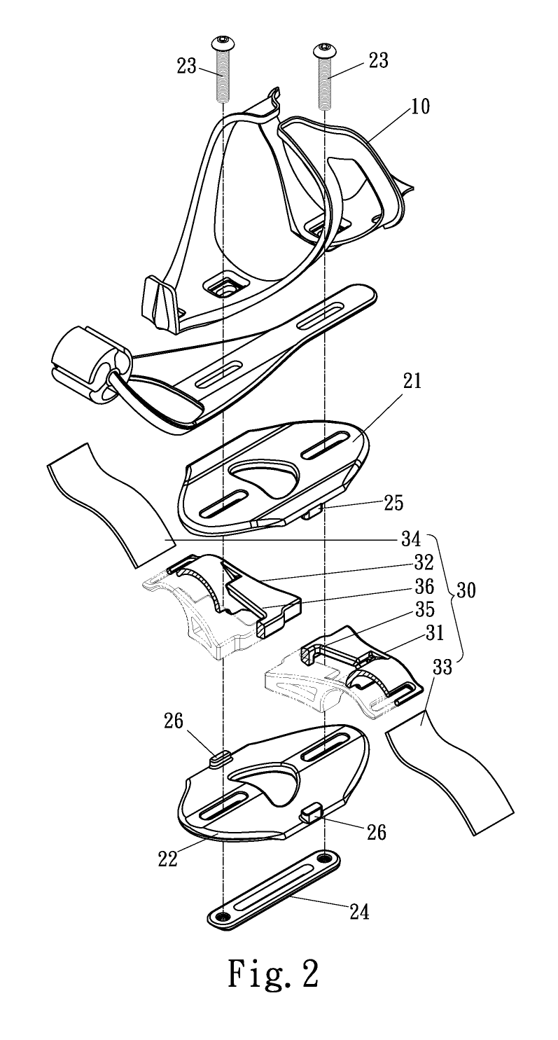

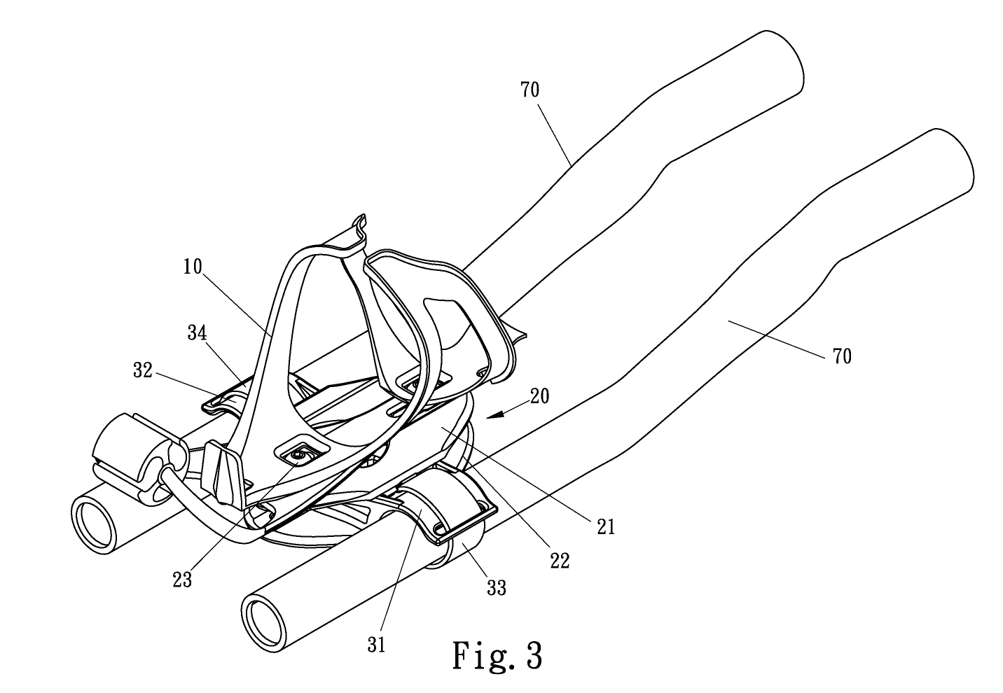

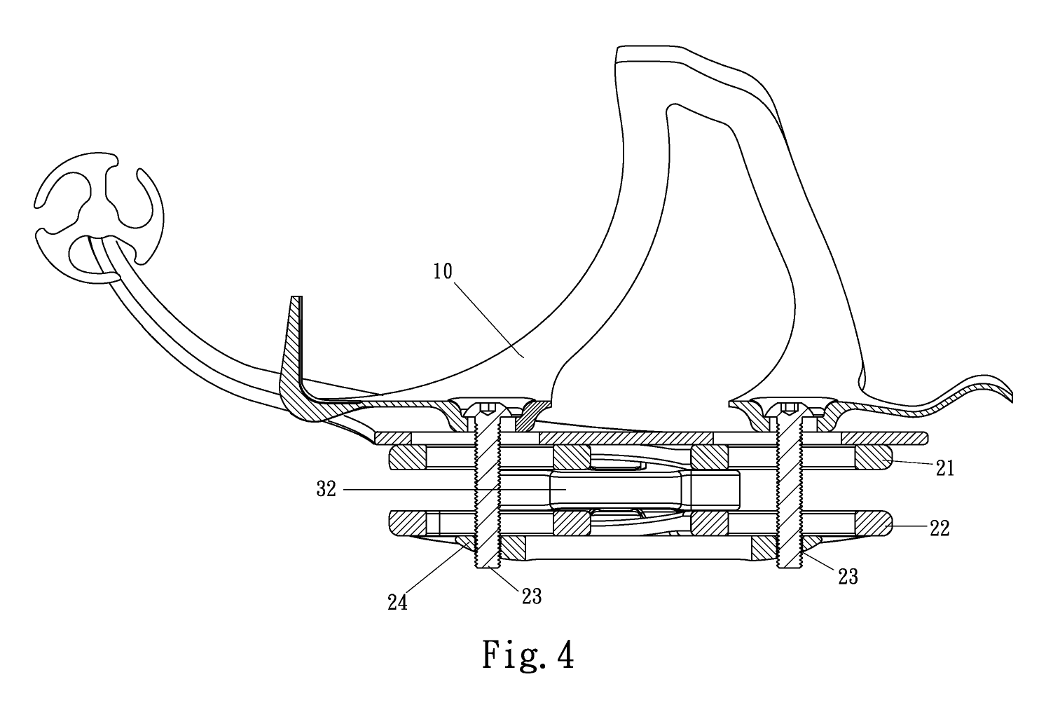

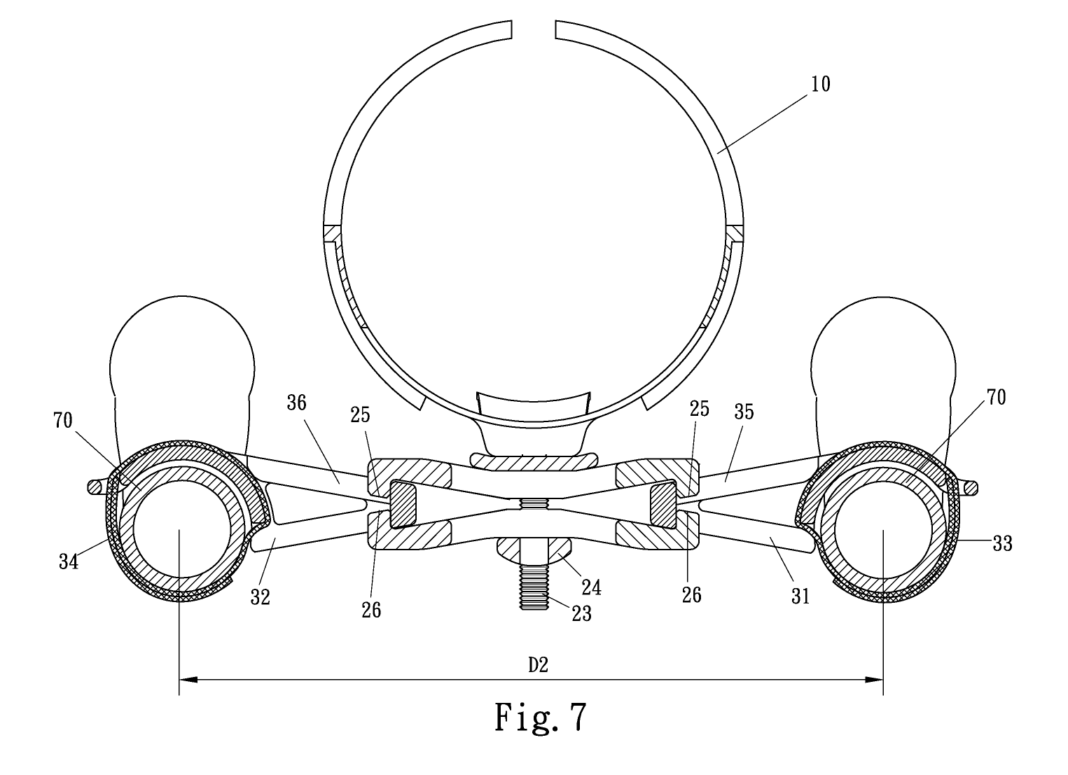

Referring to FIG. 1 through FIG. 9, the adjustable support device for bike auxiliary handles according to a preferred embodiment of the present invention comprises a support member 10, a clamping unit 20, and an adjustment unit 30.

The support member 10 is used to support an article 101, such as a water bottle, a GPS, a stopwatch or the like. In this embodiment, the support member 10 is used to support a water bottle for example.

The clamping unit 20 is perpendicularly coupled to the support member 10. The clamping unit 20 is adjustable between a tightened position and a loosened position.

The adjustment unit 30 is used for adjustment in the horizontal direction, so that the clamping unit 20 is coupled to two parallel auxiliary handles 70. When the clamping unit 20 is at the loosened position, the adjustment unit 30 can be adjusted between a minimum distance D1 and a maximum distance D2. When the clamping unit 20 is at the tightened position, the adjustment unit 30 is positioned in place.

When the present invention is in use, the support member 10 can be used as a water bottle support to support a water bottle, or a stopwatch support to support a stopwatch, or a connection support to connect with a GPS.

The clamping unit 20 comprises a first clamping member 21, a second clamping member 22, a pair of coupling units 23, 24, and a pair of interval limit members 25, 26. The first clamping member 21 and the second clamping member 22 are perpendicularly connected to the support member 10, and cooperate with the pair of coupling units 23, 24 to wrap and fix the adjustment unit 30.

The adjustment unit 30 comprises a first adjustment member 31, a second adjustment member 32, a first connection member 33, a second connection member 34, and a pair of restrained member 35, 36. The first adjustment member 31 and the second adjustment member 32 can be horizontally adjusted between the minimum distance D1 and the maximum distance D2. The first connection member 33 and the second connection member 34 are used to connect the pair of bike auxiliary handles 70. The pair of restrained members 35, 36 is restrained by the interval limit members 25, 26 of the clamping unit 20, and can be separated up to the maximum distance D2.

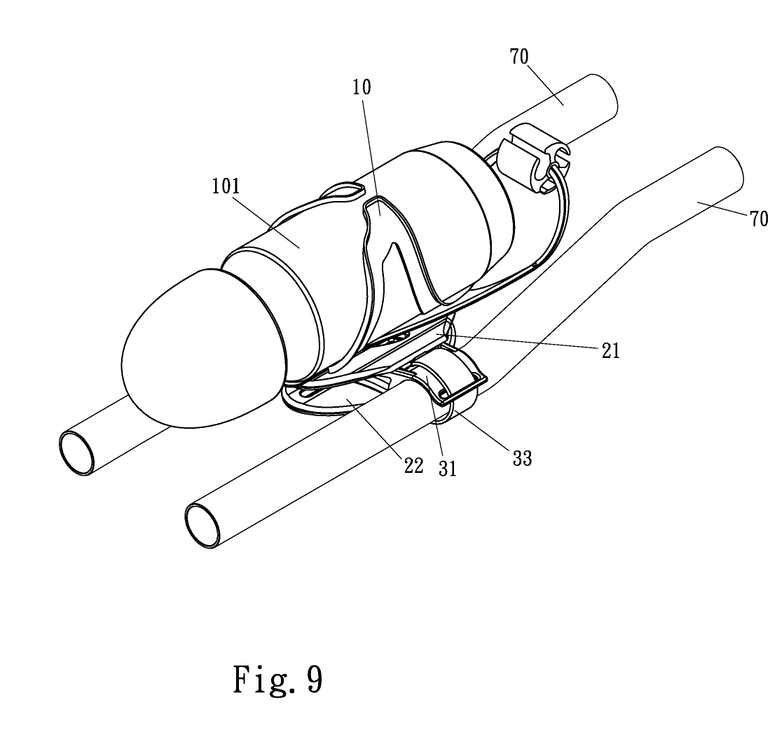

Referring to FIG. 9, the support member 10 can be turned 180 degrees in an opposite direction for the user to take the article 101 according to his/her usual practice.

The present invention can be used in the following two ways:

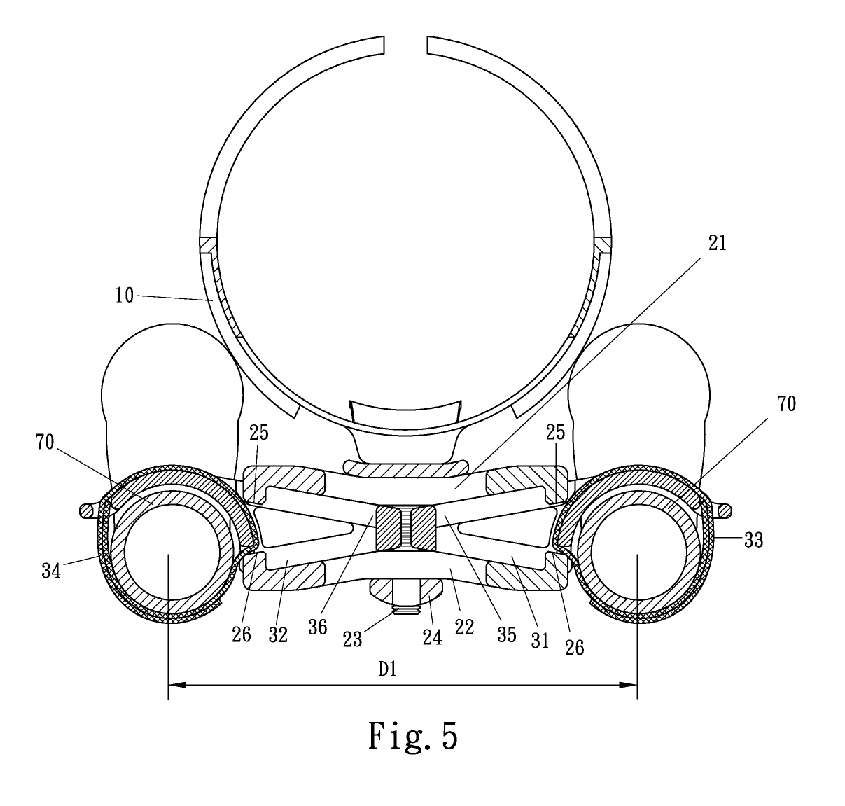

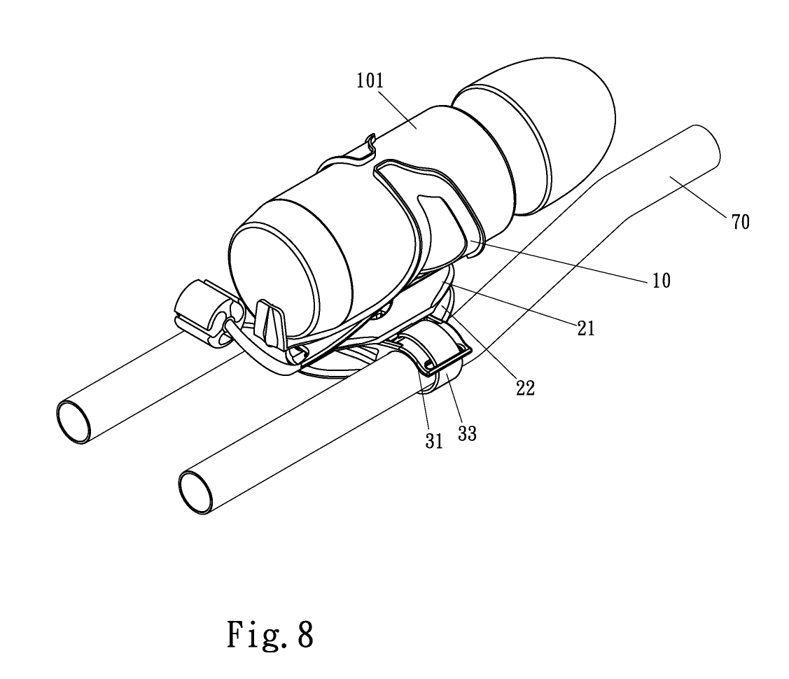

(A) In the minimum mode: Referring to FIG. 5 and FIG. 8, the two parallel auxiliary handles 70 can be adjusted to the minimum distance D1. The coupling units 23, 24 of the clamping unit 20 are loosened, and then the first and second adjustment members 31, 32 of the adjustment unit 30 are adjusted to the minimum distance D1 between the first and second clamping members 21, 22 of the clamping unit 20. The two auxiliary handles 70 are moved along with the movement of the first and second adjustment members 31, 32 of the adjustment unit 30. After adjustment, the coupling units 23, 24 of the clamping unit 20 are tightened again. In this way, the two auxiliary handles 70 are adjusted to the minimum distance D1, the support device coupled on the auxiliary handles 70 is also adjusted to the minimum distance D1, and the support member 10 is used to support the article 101.

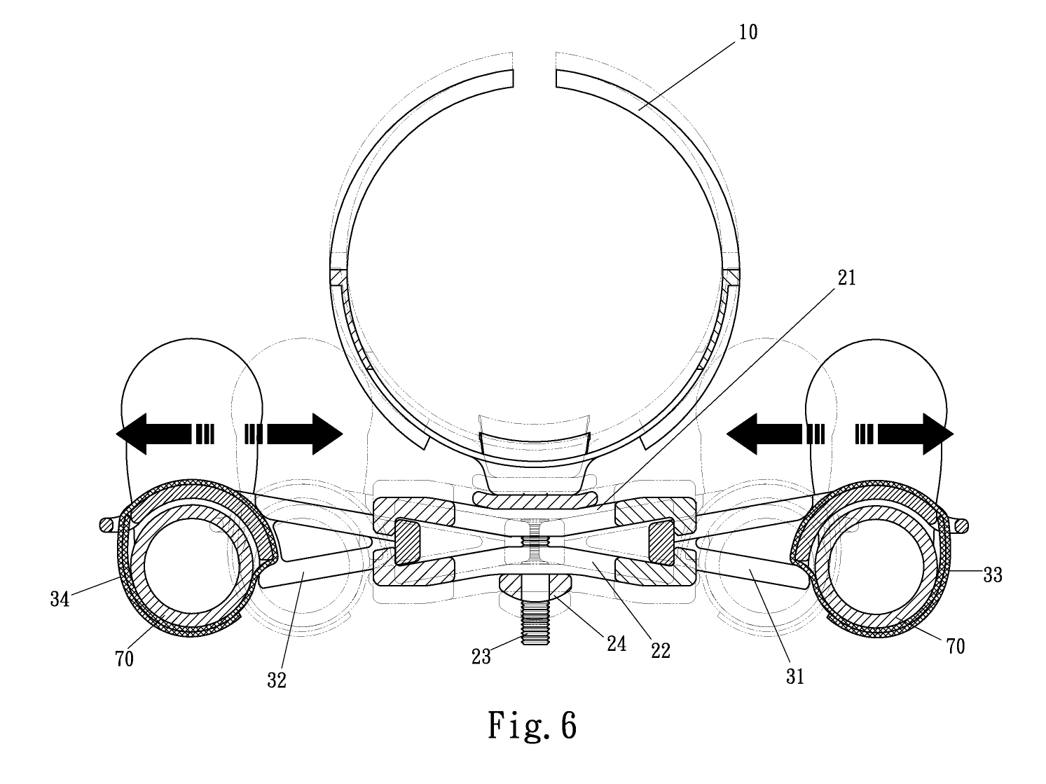

(B) In the maximum mode: Referring to FIG. 6 and FIG. 8, the two parallel auxiliary handles 70 can be adjusted to the maximum distance D2. The coupling units 23, 24 of the clamping unit 20 are loosened, and then the first and second adjustment members 31, 32 of the adjustment unit 30 are adjusted to the maximum distance D2 between the first and second clamping members 21, 22 of the clamping unit 20. The two auxiliary handles 70 are adjusted to the maximum distance D2 from the minimum distance D1 along with the movement of the first and second adjustment members 31, 32 of the adjustment unit 30. The pair of interval limit members 25, 26 and the pair of retrained members 35, 36 are restrained with each other, not exceeding the maximum distance D2. After adjustment, the coupling units 23, 24 of the clamping unit 20 are tightened again. In this way, the two auxiliary handles 70 are adjusted to the maximum distance D2, the support device coupled on the auxiliary handles 70 is also adjusted to the maximum distance D2, and the support member 10 is used to support the article 101.

Accordingly, the present invention has the following advantages:

(1) The distance between the two auxiliary handles and the support device can be adjusted as desired. The two parallel auxiliary handles can be adjusted between the minimum distance and the maximum distance according to the user's practice, and the support device connected between the two auxiliary handles is adjusted accordingly.

(2) The direction of the support member can be adjusted. The support member of the present invention can be used to support a water bottle or any article. The feature is that the support member can be turned 180 degrees in an opposite direction for the user to get the article with ease according to the user's practice.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An adjustable support device for bike auxiliary handles, comprising a support member, a clamping unit and an adjustment unit;
the support member being adapted to support an article;
the clamping unit being perpendicularly coupled to the support member, the clamping unit being adjustable between a tightened position and a loosened position;
the adjustment unit being used for adjustment in a horizontal direction for the clamping unit to be coupled to two parallel auxiliary handles; wherein when the clamping unit is at the loosened position, the adjustment unit is adjustable between a minimum distance and a maximum distance, wherein when the clamping unit is at the tightened position, the adjustment unit is positioned in place.

2. The adjustable support device as claimed in claim 1, wherein the support member is one of a water bottle support to support a water bottle, a stopwatch support to support a stopwatch and a connection support to connect with a GPS.

3. The adjustable support device as claimed in claim 1, wherein the clamping unit comprises a first clamping member, a second clamping member, a pair of coupling units and a pair of interval limit members, the first clamping member and the second clamping member being perpendicularly connected to the support member and cooperating with the pair of coupling units to wrap and fix the adjustment unit.

4. The adjustable support device as claimed in claim 1, wherein the adjustment unit comprises a first adjustment member, a second adjustment member, a first connection member, a second connection member and a pair of restrained member, the first adjustment member and the second adjustment member being horizontally adjusted between the minimum distance and the maximum distance, the first connection member and the second connection member being used to connect the pair of bike auxiliary handles, the pair of restrained members being restrained by the interval limit members of the clamping unit and can be separated up to the maximum distance.

5. The adjustable support device as claimed in claim 1, wherein the support member is able to be turned 180 degrees in an opposite direction.

6. The adjustable support device as claimed in claim 3, wherein the adjustment unit comprises a first adjustment member, a second adjustment member, a first connection member, a second connection member and a pair of restrained member, the first adjustment member and the second adjustment member being horizontally adjusted between the minimum distance and the maximum distance, the first connection member and the second connection member being used to connect the pair of bike auxiliary handles, the pair of restrained members being restrained by the interval limit members of the clamping unit and can be separated up to the maximum distance.
